(19) United States
(12) Patent Application Publication
(10) Pub. No.: US 2006/0207976 A1
(43) Pub. Date: Sep. 21, 2006

(54) Laser material micromachining with green femtosecond pulses

(76) Inventors: James M. Bovatsek, San Jose, CA (US); Alan Y. Arai, Fremont, CA (US); Lawrence Shah, Ypsilanti, MI (US); Fumiyo Yoshino, Santa Clara, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/336,383

(22) Filed: Jan. 20, 2006

Related U.S. Application Data
(60) Provisional application No. 60/646,101, filed on Jan. 21, 2005.

(51) Int. Cl. B23K 26/38; B23K 26/06

(52) U.S. Cl. 219/121.69; 264/400

(57) ABSTRACT

Various embodiments of a system described herein relate to micromachining materials using ultrashort visible laser pulses. The ultrashort laser pulses may be green and have a wavelength between about 500 to 550 nanometers in some embodiments. Additionally, the pulses may have a pulse duration of less than one picosecond in certain embodiments.

### PRIORITY APPLICATION

This application claims priority to U.S. Patent Application No. 60/646,101 filed Jan. 21, 2005, entitled “LASER MATERIAL MICROPROCESSING WITH GREEN FEMTOSECOND PULSES,” (Attorney Docket No. IMRAA.033PR), which is hereby incorporated by reference herein in its entirety.

### BACKGROUND

1. Field of the Invention

The apparatus and methods relate to pulsed lasers and to micromachining with pulsed lasers.

2. Description of the Related Art

Many materials can be micromachined using lasers and in particular pulsed lasers. In a laser micromachining process, laser energy is directed into a medium so as to alter the physical or structural characteristics of the medium. Typically, a portion of the irradiated material is removed, for example, by ablation. Laser micromachining can be used, for example, to drill, cut, scribe, and mill materials so as to form structures including, for example, channels, grooves, or holes, or to form other features in the material.

In some micromachining processes, the laser energy comprises one or more laser pulses. However, when more than a single laser pulse is used, residual heat can accumulate in the bulk of the remaining material as successive pulses are incident upon the material. If the laser pulse repetition rate is sufficiently high, the accumulated heating can become severe enough to cause undesirable effects, such as melting, oxidation, or other changes to the atomic arrangements in and/or on regions of the material. These regions are known as Heat Affected Zones (HAZ), and they lead to imprecision in the micromachining process.

In some pulsed laser micromachining processes, a higher laser pulse repetition rate is necessary to make the micromachining process economically feasible. Accordingly, apparatus and methods are needed that enable pulsed laser micromachining at higher repetition rates.

### SUMMARY

Various embodiments of systems and methods to laser micromachine material with green femtosecond pulses are disclosed. One embodiment comprises a method comprising producing a visible light beam comprising femtosecond optical pulses having a wavelength between about 490 and 550 nanometers and micromachining a region of a surface by directing at least a portion of the visible light beam into the region of the surface.

Another embodiment comprises a system for micromachining. The system comprises a light source producing a beam of visible light comprising femtosecond pulses having a wavelength between about 490 and 550 nanometers, and material positioned in the beam such that the material is micromachined by the beam.

Another embodiment comprises a system for performing micromachining on an object. The system comprises a visible laser light source that outputs a visible light beam comprising femtosecond duration optical pulses having a wavelength between about 490 and 550 nanometers and illuminates a spatial region of the object with the visible light. The system further comprises a translation system for translating the beam or the spatial region, wherein the translation system is configured to alter the relative position of the beam and object such that the visible laser beam micromachines the object.

### BRIEF DESCRIPTION OF THE DRAWINGS

FIG. 1 shows an embodiment of a system for micromachining a material comprising a visible light laser source, focusing optics, and a translation system that supports the material.

FIG. 2 shows a schematic diagram of an embodiment of a visible laser light source that comprises an oscillator, a pulse stretcher, an optical amplifier, and a grating compressor.

FIG. 3A shows a schematic diagram of one embodiment of a grating compressor that comprises first and second gratings and a mirror.

FIG. 3B shows a schematic diagram of one embodiment of a grating compressor that comprises one grating and two retroreflectors.

FIG. 4 is a scanning electron microscope micrograph showing a feature micromachined in Teflon® PFA using 522 nanometer ultrashort laser pulses at a 100 kHz repetition rate.

FIGS. 5A and 5B are optical micrographs of features micromachined in polyethylene terephthalate using 1045 nanometer (FIG. 5A) and 522 nanometer (FIG. 5B) ultrashort laser pulses at a 100 kHz repetition rate.

FIGS. 5C and 5D are optical micrographs of features micromachined in gold using 1045 nanometer (FIG. 5C) and 522 nanometer (FIG. 5D) ultrashort laser pulses at an 800 kHz repetition rate.

FIG. 6A is an optical micrograph showing the removal, by 522 nanometer ultrashort laser pulses, of a narrow channel in a thin chrome film deposited on a quartz substrate.

FIG. 6B is an optical micrograph of a region of the channel shown in FIG. 6A.

FIG. 6C is an atomic force microscope scan of a region of the quartz substrate shown in FIG. 6B.

FIG. 7 shows an embodiment of the micromachining system in which the translation system comprises a rotating or tilting mirror.

FIG. 8 shows an embodiment of the micromachining system that uses a mask to form a pattern in or on the material.

### DETAILED DESCRIPTION OF CERTAIN PREFERRED EMBODIMENTS

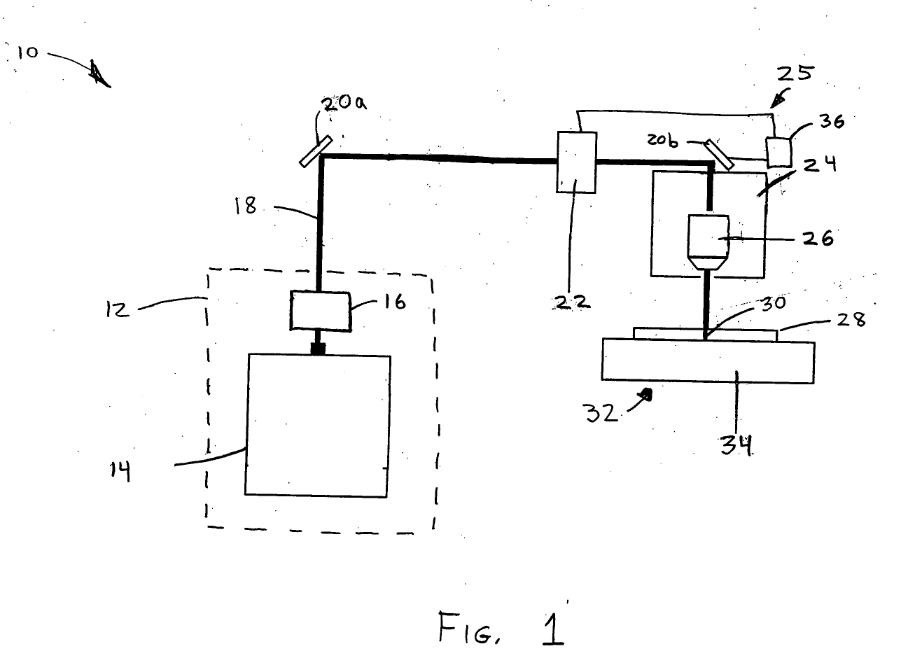

A system 10 configured to micromachine a material is shown in FIG. 1. This system 10 comprises a visible laser light source 12 that outputs visible light. The visible laser light source 12 has an output wavelength in the green region of the visible optical spectrum, e.g., between about 500 and 550 nanometers. This wavelength range may also be between about 450 and 700 nanometers in some embodiments.

The visible laser light source 12 comprises a laser configured to produce ultrashort pulses having pulse durations from about 100 fs to 20 ps. In one embodiment, the laser light source 12 comprises a Yb-doped fiber laser 14 that outputs light having a wavelength of approximately 1045 nanometers. An example Yb-doped, amplified fiber laser 14 comprises the FCPA μJewel available from IMRA America, Ann Arbor Mich. This fiber laser has a pulse repetition rate between about 100 kHz and 5 MHz and is capable of outputting ultrashort pulses having pulse durations between about 200 and 500 fs. The pulse duration may also be between 300 and 700 fs in some embodiments. Repetition rates and pulse durations outside these ranges may also be possible in other embodiments.

The visible laser light source 12 further comprises a frequency doubler 16 that receives the optical pulses from the Yb-doped fiber laser 14. One preferred embodiment of the frequency doubler 16 utilizes non-critically phase matched lithium triborate (LBO) as the nonlinear media as this can maximize conversion efficiency and output beam quality. The frequency doubler may also comprise nonlinear media such as beta-barium borate (BBO), potassium titanyl phosphate (KTP), bismuth triborate BiB₃O₆, potassium dihydrogen phosphate (KDP), potassium dideuterium phosphate (KD*P), potassium niobate (KNbO₃), lithium niobate (LiNbO₃) and may include appropriate optics to direct or focus the incident beam into the nonlinear medium, to increase conversion efficiency, and collimate the second harmonic output beam. In some embodiments, the frequency doubler produces a frequency doubled output at a wavelength of about 522 nm through second harmonic generation. This output from the frequency doubler 16 and from the visible laser light source 12 is shown as a beam 18 in FIG. 1.

Other types of light sources and specifically other types of visible laser light sources 12 may be employed. Other types of lasers may be employed. For example, other types of fiber and non-fiber pulsed lasers may be employed. In some embodiments, for example, the light source 12 may comprise a solid state laser such as a Nd:YAG laser that outputs light at approximately 1064 nm. Frequency doubling and second harmonic generation may or may not be employed in different embodiments. In various preferred embodiments, ultrashort pulses, for example, femtosecond pulses less than one picosecond are useful. Certain pulsed fiber lasers may provide the ability to produce such ultrafast pulses at the suitable visible wavelength.

The system 10 may include mirrors 20a, 20b that direct the beam 18 to other components of the system 10. The system 10 may comprise a power adjust assembly 22 configured to attenuate the average power and pulse energy in the beam 18. In some embodiments, the power adjust assembly 22 comprises a neutral density filter and may comprise a graduated neutral density filter. In other embodiments, the power adjust assembly 22 comprises a polarizer and a wave plate that is rotatable with respect to the polarizer.

In some embodiments, a feedback system 25 is used to monitor and control the power or pulse energy in the beam 18. The feedback system 25 comprises the mirror 20b, which is partially transmissive of the laser light beam 18. The feedback system 25 further comprises a controller 36 that is connected to the power adjust assembly and is configured to receive a portion of the light transmitted from the mirror 20b. The controller 36 may include an optical sensor or detector that is sensitive to light incident thereon. The controller 36 can monitor the transmitted light and suitably regulate the power adjust assembly 22 so as to control the average power and/or the pulse energy in the beam 18.

The system 10 directs the laser beam 18 onto a material 28 and, in particular, into a target region 30 in and/or on the material 28 so as to micromachine features or structures. This material 28 may comprise metal, semiconductor, or dielectric material. For example, the material 28 may include copper, aluminum, gold, and chrome. The material 28 may also comprise crystal or polymer. Additionally the material 28 may comprise glass or other dielectric materials. Some examples of material that may be employed include fluorine-doped silica glass and high bandgap crystalline materials such as quartz, sapphire, calcium fluoride, magnesium fluoride, barium fluoride, and beta barium borate. Also, the material 28 may comprise silica glass based dielectrics or “low-k” dielectrics commonly used to increase the performance of semiconductor devices, for example, microprocessors. The material 28 may comprise organic, inorganic, or hybrid materials. Additionally, the material 28 may comprise a combination of these materials. Other materials may be used.

Suitable materials 28 also include Coming Pyrex® glass, borosilicate glass, silicon carbide, crystalline silicon, zinc oxide, and nickel. Additionally, various nickel-chromium alloys such as, for example, Inconel® (Special Metals Corporation, New Hartford, N.Y.), e.g., Inconel® alloy 625, may be used. In certain embodiments, the material 28 may comprise nickel-titanium alloys such as, for example, shaped-memory or superelastic alloys such as nitinol (Nlckel TItanium Navel Ordnance Laboratory). Further, experiments indicate that such materials may be micromachined at lower levels of laser fluence when using green (e.g., 522-nm light) rather than infrared (e.g., 1045-nm light). In other micromachining process, indium-tin-oxide (ITO) may be used, and in particular transparent-conducting-oxide ITO may be used.

In some embodiments the system 10 is configured to remove portions of a thin film deposited on a substrate, such as, for example, a chrome film deposited on quartz. Certain embodiments of the system 10 may be configured to remove portions of the thin film without significant damage to the underlying substrate. In some embodiments, the thin film may comprise a multilayer stack of thin films such as, for example, alternating thin layers of metal and dielectric materials.

The system 10 further includes optics 26 disposed to receive visible light output from the visible laser light source 12. The optics 26 may include, for example, a microscope objective that focuses the beam 18 into the target region 30. In some embodiments, the optics 26 focuses the laser beam 18 to achieve a high fluence (energy per unit area) in the target region 30. Note that the drawing in FIG. 1 is schematic and does not show the convergence of the beam, although optics that focuses the beam may be employed.

The optics 26 may have a numerical aperture (NA) less than about 1.0 and between about 1.0 and 0.4 in some embodiments. The reduced resolution due to use of lower numerical aperture optics, however, may be offset by using shorter wavelengths such as visible wavelengths. Moreover, the low NA focusing objective facilitates micromachining of three-dimensional features and structures due to the longer depth of focus relative, e.g., to oil-and water-immersed objectives with NA>1.0. The visible wavelength near about 520 nm is also more compatible with standard high magnification objectives used in visible microscopy than near infrared (NIR) wavelengths. As such, the insertion loss and beam aberration introduced by the objective is significantly reduced. Other types of optics 26 may be employed, and the optics may be excluded in certain embodiments.

In some embodiments of the system 10, the optics 26 are mounted on a focusing stage 24 that can be translated or moved to align and focus the beam so that a portion of the beam 18 with high fluence can be directed into suitable regions of the material 28. Other embodiments may use additional optics and/or mirrors to adjust the focus of the optics 26.

The system 10 further comprises a translation system 32 for moving the target region 30. The medium 28 may, for example, be mounted on a translation stage 34 that is translated or otherwise moved with respect to the laser beam 18. In other embodiments, the laser beam 18 may be translated, for example, using a mirror that can be rotated or tilted. The laser beam 18 may be translated or moved by moving other optical elements, for example, by shifting the microscope lens 26 or the focusing stage 24. Other configurations and arrangements for moving the beam 18 with respect to the medium 28 or otherwise moving the target region 30 may be employed. In certain preferred embodiments, the translation system 32 is configured so that large regions or many regions in the material 28 can be laser machined.

The visible light laser pulses incident on the material 28 alter the physical characteristics and/or structure of the material 28. Micromachining of the material 28 using ultrashort laser pulses allows for removal or ablation of the material without disadvantageously heating the remaining bulk matter. One reason that the bulk material is not significantly heated may be that the laser pulse duration, which is the time during which laser energy is deposited into the material, is less than a characteristic time in which energy is transferred from the material's electronic structure to its phononic structure. Therefore, provided the fluence is sufficiently high, the irradiated material is ablated before significant heating can occur in the surrounding material.

As referred to above, systems 10 such as described above offer many advantageous technical features. Use of frequency-doubled 1045-nanometer radiation, for example, provides numerous benefits. The shorter wavelength allows for tighter focusing due to the reduction in the diffraction limited spot size. Achieving high focal intensity/fluence with relatively low incident pulse energy is therefore possible.

For weakly-absorbing or transparent materials, an ablation threshold, which is the fluence at which absorbed laser energy is sufficient to break chemical bonds in the material so as to permit ablation to occur, has been found to be lower for shorter wavelength light. The lower ablation threshold allows micromachining to be performed at fluences that are sufficiently low such that significant heating of the surrounding material does not occur. Accordingly, the use of shorter wavelengths results in reduced formation of HAZ and higher quality micromachining. For example, experiments have shown that the laser-damage threshold of Pyrex® glass is lower for 522-nm ultrashort pulses than for 1045-nm ultrashort pulses, despite the fact that the material is transparent to both wavelengths.

Without subscribing to any particular theory or explanation, one possible reason for the lower ablation threshold at shorter wavelengths is that the shorter wavelength light is more effective at producing free electrons that can break bonds in the bulk of the material. Free electrons can be produced by a variety of processes such as, for example, photoionization processes in which incident light has sufficient energy to free an electron from a valence band in the material. Typically, the incident light energy must exceed a bandgap energy, which is the energy difference between an ionization band and the valence band. In a single-photon ionization process, a single photon with energy larger than the bandgap energy can ionize an electron. The rate at which single-photon ionization occurs generally depends linearly on the laser intensity/fluence. In a multi-photon ionization process, a number of photons, each having an energy below the bandgap energy, nonetheless can ionize an electron, because the sum of their energies exceeds the bandgap energy. The rate at which multi-photon ionization occurs depends nonlinearly on the laser intensity/fluence, and at a given fluence, the rate is larger if a smaller number of photons are involved in the process. Accordingly, the multi-photon ionization rate is larger for shorter wavelength light, because shorter wavelength photons have larger energies, and fewer shorter wavelength photons are needed to exceed the bandgap energy. Therefore, it is possible that multi-photon ionization may contribute toward the lower ablation threshold at shorter wavelengths. However, it is also possible that the multi-photon ionization process does not play a significant, or even any, role in lowering the ablation threshold and that other physical processes may be responsible in whole or in part for the lower ablation threshold at shorter wavelengths.

In certain embodiments, the system 10 may be used to micromachine a dielectric material, while in other embodiments, the system 10 may be used to micromachine a thin layer disposed on a dielectric, without significantly damaging the dielectric. For example, in one embodiment, a thin film may be removed from a substantially transparent substrate (e.g., a glass or Pyrex® substrate), without substantial damage to the substrate material. The use of visible (e.g., green) wavelength light is advantageous, because it permits fine resolution features to be machined, because feature resolution is proportional to wavelength. Accordingly, shorter wavelengths permit smaller features to be machined. Further, in some micromachining processes, the shorter wavelength light can pass through the substrate without being substantially absorbed and without causing significant damage to the substrate.

As the wavelength decreases below the green portion of the spectrum, there is an increased likelihood of damage to the substrate. For wavelengths below about 400 nm, for example, many transparent materials begin to show an increase in linear absorption, which will increase likelihood of damage to the glass. Use of such shorter wavelengths reduces the ability of a system to remove a thin film without also damaging or removing portions of the substrate. Use of such shorter wavelengths also decreases the yield of the process and increases cost.

The ability to machine materials at lower operating fluences is advantageous, because it results in reduced HAZ (Heat Affected Zones) and thereby improves precision and quality. Once ablation begins in a material, various avenues exist for coupling energy into the material over longer time scales, which results in the generation of heat. For example, plasma that forms during the ablation process can absorb light, thus heating the plasma and the surrounding material. In addition, absorption due to molecular defect formation within the material (due to material interaction with intense ultrashort pulses) and absorption by residual debris from the ablation process can cause heating of the material during the laser machining. The negative effects of these absorption processes can be reduced if laser machining can be performed at lower operating fluences at shorter wavelengths.

Also, since substantially many optical objectives have been designed for biological microscopy, the performance of these microscope objectives (such as optical transmission and aberration correction) is improved or optimized for visible wavelengths. Accordingly, by using the second harmonic of the Yb-based laser, the resultant visible wavelength allows for simple integration into existing optical microscope systems. Micromachining can therefore be integrated in parallel together with a rudimentary inspection system.

Pulsed laser micromachining is a complex and challenging process. Techniques that may be well-suited for one class of materials may be inappropriate for another class. Accordingly, identifying a regime (e.g., wavelength, pulse duration, pulse repetition rate, pulse energy, laser power) wherein micromachining is possible appears to provide benefits such as, for example, improved quality machining (e.g., reduced formation of HAZ, cleaner cuts, etc.), use of smaller spot sizes, lower optical losses, higher focal intensity/fluences, and improved integration into existing microscope systems, etc., that might not otherwise available.

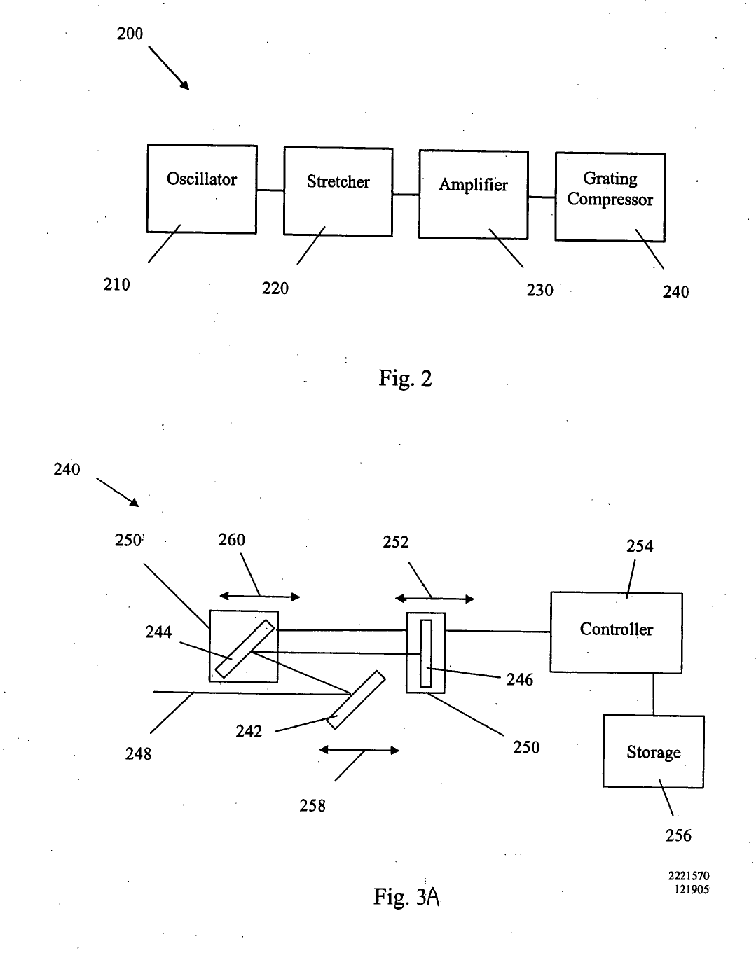

In one preferred embodiment, a laser source 200 such as schematically shown in FIG. 2 comprises, for example, a modified FCPA μJewel from IMRA America. Additional details regarding a variety of laser sources 200 are disclosed in U.S. patent application Ser. No. 10/992,762 entitled “All-Fiber Chirped Pulse Amplification Systems” (IM-114), filed Nov. 22, 2004, and U.S. Pat. No. 6,885,683 entitled “Modular, High Energy, Widely-tunable Ultrafast Fiber Source,” issued Apr. 26, 2005, both of which are incorporated by reference herein in their entirety. Generally, such a laser source 200 comprises an oscillator 210, a pulse stretcher 220, an optical amplifier 230, and a grating compressor 240.

The oscillator 210 may comprise a pair of reflective optical elements that form an optical resonator. The oscillator 210 may further include a gain medium disposed in the resonator. This gain medium may be such that optical pulses are generated by the oscillator 210. The gain medium may be optically pumped by a pump source (not shown). In one embodiment, the gain medium comprises doped fiber such as Yb-doped fiber. The reflective optical elements may comprise one or more mirrors or fiber Bragg gratings in some embodiments. The reflective optical elements may be disposed at the ends of the doped fiber. Other types of gain mediums and reflectors as well as other types of configurations may also be used. The oscillator 210 outputs optical pulses having a pulse duration or width (full width half maximum, FWHM), τ, and a repetition rate, Γ.

The pulse stretcher 220 may comprise an optical fiber having dispersion. The pulse stretcher 220 is optically coupled to the oscillator 210 and disposed to receive the optical pulses output by the oscillator. In certain embodiments, the oscillator 210 and the pulse stretcher 220 are optical fibers butt coupled or spliced together. Other arrangements and other types of pulse stretchers 220 may also be used. The output of the pulse stretcher is a chirped pulse. The pulse stretcher 220 increases the pulse width, τ, stretching the pulse, and also reduces the amplitude of the pulse.

The pulse stretcher 220 is optically coupled to the amplifier 230 such that the amplifier receives the stretched optical pulse. The amplifier 230 comprises a gain medium that amplifies the pulse. The amplifier 230 may comprise a doped fiber such as a Yb-doped fiber is some embodiments. The amplifier 230 may be optically pumped. A same or different optical pump source may be used to pump the oscillator 210 and the amplifier 230. The amplifier 230 may be non-linear and may introduce self-phase modulation. Accordingly, different amplitude optical pulses may experience different amounts of phase delay. Other types of amplifiers and other configurations may be used.

The grating compressor 240 is disposed to receive the amplified optical pulse from the optical amplifier 230. Different types of grating compressors 240 are well known in the art. The grating compressor 240 may comprise one or more gratings that introduce dispersion and is configured to provide different optical paths for different wavelengths. The grating compressor 240, which receives a chirped pulse, may be configured to provide for phase delay of longer wavelengths (e.g., temporally in the front of the optical pulse) that is different than the phase delay of the shorter wavelengths (e.g., temporally in the rear of the optical pulse). This phase delay may be such that in the pulse output from the compressor, the longer and short wavelengths overlap temporally and the pulse width is reduced. The optical pulse is thereby compressed.

In one preferred embodiment, the laser source 200 comprises a Yb-doped, amplified fiber laser (e.g., a modified FCPA μjewel, available from IMRA America). Such a laser offers several primary advantages over commercial solid-state laser systems. For example, this laser source provides a variable repetition rate that spans a “unique range” from about 100 kHz to 5 MHz. The variable repetition rate facilitates the optimization of the micromachining conditions for different materials, e.g., different metals, different dielectrics, etc. Higher repetition rate than solid-state regeneratively amplified systems allow greater microprocessing speed. Additionally, higher pulse energy than oscillator-only systems allows greater flexibility in focal geometry.

In one embodiment of the laser source 200, the pulse is stretched with a length of conventional step-index single-mode fiber and compressed with the bulk grating compressor 240. The large mismatch in third-order dispersion between the stretcher 220 and compressor 240 is compensated via self-phase modulation in the power amplifier 230 through the use of cubicon pulses. The cubicon pulses have a cubical spectral and temporal shape. Under the influence of self-phase modulation in the power amplifier 230, the triangular pulse shape increases the nonlinear phase delay for the blue spectral components of the pulses while inducing a much smaller nonlinear phase delay for the red spectral components. The degree of this self-phase modulation depends on the intensity of the laser pulse within the power amplifier 230. Moreover, variation in the repetition rate will cause a change in the intensity and, thus, also alter the phase delay and dispersion.

For constant average power, P_{avg}, resulting in large part from constant pumping, P_{avg}=Eₚᵤₗₛₑ×Γ, where Eₚᵤₗₛₑ is the pulse energy (J) and Γ is the repetition rate (Hz). Thus for constant average power, increasing the repetition rate causes the pulse energy to decrease. Conversely, decreasing the repetition rate causes the pulse energy to increase. Given that the pulse energy changes with repetition rate, e.g., from 3 μJ at 100 kHz to 150 nJ at 5 MHz, the degree of self-phase modulation also changes. The change in self-modulation in the amplifier 230 causes the pulse width to change. To correct for this change in pulse width caused by the variation in repetition rate, the dispersion of the grating compressor 240 can be adjusted.

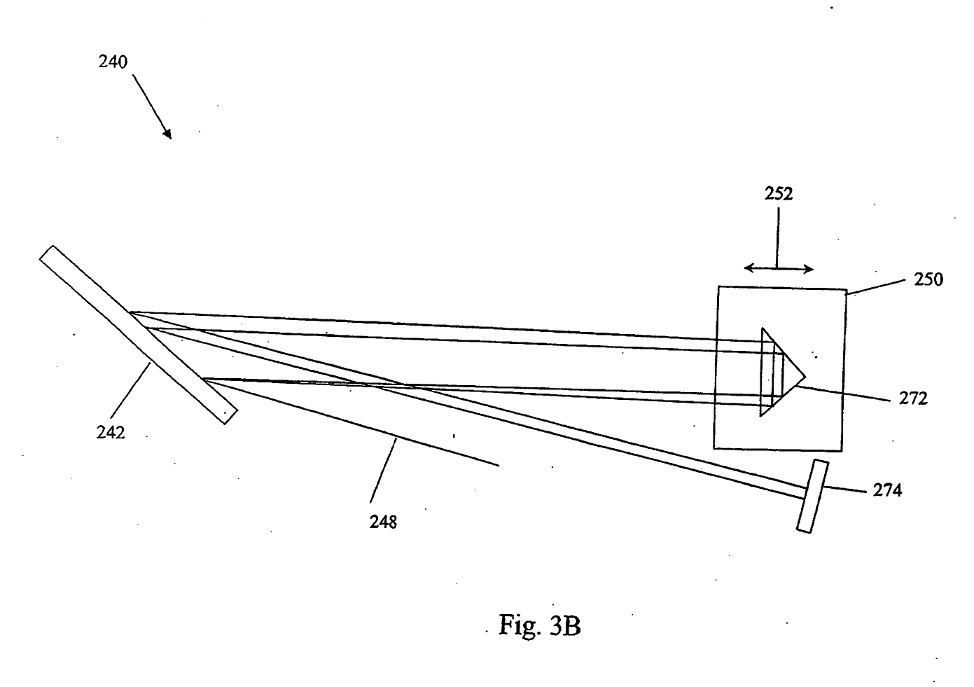

FIG. 3A schematically illustrates one embodiment of the grating compressor 240 that automatically adjusts the dispersion of the grating compressor with change in repetition rate. The grating compressor 240 includes first and second gratings 242, 244, and a mirror 246. As illustrated, an optical path extends between the first and second gratings 242, 244 and the mirror 246. Accordingly, a beam of light 248 received through an input to the grating compressor 240 is incident on the first grating 242 and diffracted therefrom. The beam 248 is subsequently directed to the second grating 244 and is diffracted therefrom toward the mirror 246. The beam 248 is reflected from the mirror 246 and returns back to the second grating 244 and is diffracted therefrom to the first grating 242. This beam 248 is then diffracted from the first grating 242 back through the input.

FIG. 3A shows the second grating 244 disposed on a translation stage 250 configured to translate the second grating in a direction represented by arrow 252. The translation stage 250 is in communication with a controller 254 that controls the movement of the translation stage. The controller 254 is also in communication with a storage device 256. This storage device may contain a look-up table that is used to correlate repetition rates with suitable settings for the grating compressor 240. The controller 254 may comprise a processor, microprocessor, CPU, computer, workstation, personal digital assistant, pocket PC, or other hardware devices. The controller 254 may implement a collection of instructions or processing steps stored in hardware, software, or firmware. The collection of instructions or processing steps may be stored in the controller 254 or in some other device or medium. Some or all of the processing can be performed all on the same device, on one or more other devices that communicates with the device, or various other combinations. The processor may also be incorporated in a network and portions of the process may be performed by separate devices in the network.

The storage device 256 may also comprise one or more local or remote devices such as, for example, disk drives, volatile or nonvolatile memory, optical disks, tapes, or other storage device or medium both those well known in the art as well as those yet to be devised. Communication may be via, e.g., hardwiring or by electromagnetic transmission and may be, e.g., electrical, optical, magnetic, or microwave, etc. A wide variety of configurations and arrangements are possible.

FIG. 3A also shows arrow 258 representing translation of the first grating 242. Either or both of these gratings 242, 244 may be translated using translators connected to the controller 254 or other controllers. Such translation of the first and/or second gratings 242, 244 changes the separation therebetween, which increase or decreases the optical path length traveled by the light between the gratings. Increasing or decreasing this optical path length increases or decreases the effects of the angular dispersion of the gratings on the beam. In certain embodiments, the mirror 246 may also be translated.

As described above, in the embodiment of the compressor grating 240 shown in FIG. 3A, translation of the grating 244 as indicated by the arrow 252 alters the optical path distance that diffracted light propagates between the gratings. Changing this optical path length alters the dispersion introduced to the beam 248 by the grating compressor 240. Accordingly, translating the second grating 244 different amounts using the translator 250 alters the dispersion of the grating compressor 240 and may be used to compensate for variation in dispersion of other portions of the laser source 200. In particular, the controller 254 may be configured to automatically induce translation of the second grating 244 via the translator 250 by an appropriate amount in response to a change in the repetition rate so as to counter the change in dispersion in the amplifier 530 that results from the change in the repetition rate.

Different configurations are possible. With reference to FIG. 3, different combinations of the gratings 242, 244 and the mirror 246 may be translated to automatically adjust the dispersion of the grating compressor 240 by altering the optical path of the beam 248, e.g., between the gratings. Additionally, either of the gratings 242, 244 and the mirror 246 may be excluded. In another embodiment, for example, the grating compressor 240 comprises the first and second gratings 242, 244 without the mirror 246. In other embodiments, more gratings may be used. Additionally, in other embodiments, a prism may be used in place of the mirror. The prism may facilitate output of the pumped laser beam 248 from the grating compressor 240 and laser source 200. Other designs are also possible.

FIG. 3B, for example, illustrates another embodiment of the compressor grating 240 that comprises a grating 242 and first and second retroreflectors 272, 274. The first retroreflector 272 is disposed on a translation stage 250, which is configured to translate the retroreflector 272 in the direction represented by the arrow 252. The translation stage 250 may be configured to operate in a substantially similar manner to that described with reference to FIG. 3A. The incident light beam 248 is received from an input to the grating compressor 240 and travels along an optical path to the grating 242 and is diffracted therefrom. The beam 248 subsequently travels to the first retroreflector 272 and is redirected back toward the grating 242. The beam 248 is diffracted from the grating 242 and travels towards the second retroreflector 274. The beam 248 reflects from the second retroreflector 274 and reverses its path through the grating compressor 240 and back through the input. The retroreflectors 272, 274 may comprise prisms that in addition to reflecting the beam, provide that the reflected beam is laterally displaced with respect to the incident beam.

Translation of the first retroreflector 272 as indicated by the arrow 252 alters the optical path distance traveled by the beam 248 between reflections from the grating 242 and thus alters the dispersion introduced to the beam 248 by the compressor grating 240. Other aspects of the operation of the grating compressor 240 shown in FIG. 3B may be generally similar to those of the grating compressor 240 shown in FIG. 3A. Still other configurations, both well known in the art as well as those yet to be devised may be used.

Further, in some embodiments, an optical detector (e.g., a photodiode) may be included that monitors the repetition rate. The controller 254 may use this information from the optical detector. In other embodiments, the optical detector provides a measure of the pulse width and the controller 254 uses this information to automatically adjust the dispersion of the grating compressor 240. Thus, a feedback system that includes the optical detector and the controller 254 may be included to automatically adjust the dispersion of the grating compressor 240. Additional details regard using feedback to control the laser system 200 is disclosed in U.S. patent application Ser. No. 10/813,269 entitled “Femtosecond Laser Processing System with Process Parameters, Controls and Feedback,” (IM-110) filed Mar. 31, 2004, which is incorporated by reference herein in its entirety. Other variations in design are possible.

As described herein, this laser source 200 may be particularly useful for material micromachining. The combination of ultrashort pulse duration, relatively high pulse energy, and visible (e.g., green) wavelength makes possible high quality and high precision micromachining for a significant variety of laser machining processes. The high quality micromachining results from, for example, reduced formation of HAZ (Heat Affected Zones) and provides an ability to machine precise, controlled, repeatable cuts in the material over a wide range of laser fluences. The ability to use relatively low NA focal objectives simplifies the optical layout and provides long working distance and long depth of focus which are useful for micromachining three-dimensional structures.

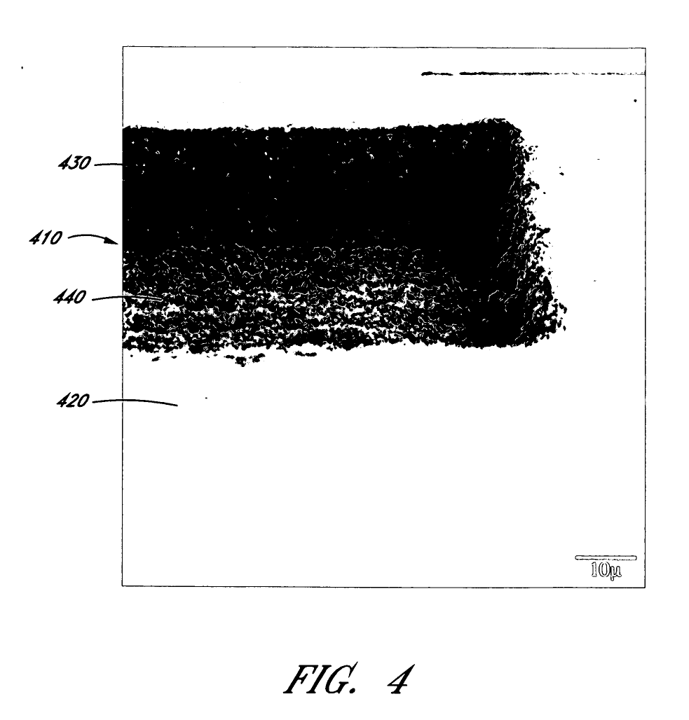

Embodiments of the system 10 may be used to machine a variety of materials, including, for example, polymer compounds. FIG. 4 shows a scanning electron microscope micrograph of a substantially rectilinear groove 410 micromachined in Teflon® PFA (polytetrafluoroethylene perfluoroalkoxy) 420. The micromachining process used ultrashort laser pulses having a 522 nanometer wavelength, a 100 kHz repetition rate, and a pulse width of about 450 fs. The groove 410 has substantially constant width and depth, and its edges 430 and bottom 440 are reasonably smooth and sharp. The edges 430 and the bottom 440 have a surface roughness of less than about 200 nanometers, as measured by, for example, a root-mean-square surface height. In other experiments, the surface roughness may be less than about 100 nanometers or less than about 10 nanometers. The groove 410 also does not show evidence of significant HAZ (Heat Affected Zones). For example, all areas of the surface of the material 420 that were not exposed to the laser radiation are substantially smooth, uniform, and level to within a distance of about 1 micron or less to the edges 430 of the groove 410. In contrast, micromachining experiments conducted on various polymers using ultrashort laser pulses having a 1045 nm wavelength resulted in significant heating of the material. These experiments show that such heating may cause portions of the material surface near the edges of micromachined features to become raised and/or bulged. The raised and/or bulged portions may extend for several micrometers, or even for tens of micrometers, away from the features. Furthermore, melting, and in some cases, actual burning, of the material has been observed. Since polymers generally have low thermal conductivity, such melting and burning may be a result of heat accumulation as successive pulses are incident upon the material. Accordingly, the use of visible (e.g., green) laser light is advantageous for machining polymeric materials.

A direct comparison was also made between micromachining at green (522 nm) and at infrared (1045 nm) wavelengths to show the advantages of using shorter wavelengths. In this comparison experiment, PET (polyethylene terephthalate) was micromachined with 1045 nm and 522 nm femtosecond laser pulses at a 100 kHz repetition rate. The duration of the pulses was about 450 fs. In this experiment, the same 1045 nm laser 14 (see FIG. 1) was used as a light source for the 1045 nm and 522 nm laser pulses; the only difference being that the 522 nm pulses were passed through the frequency doubler 16. Therefore, stability of the laser pulse energy, which is important for precision laser machining, was approximately the same for the green and the infrared micromachining process.

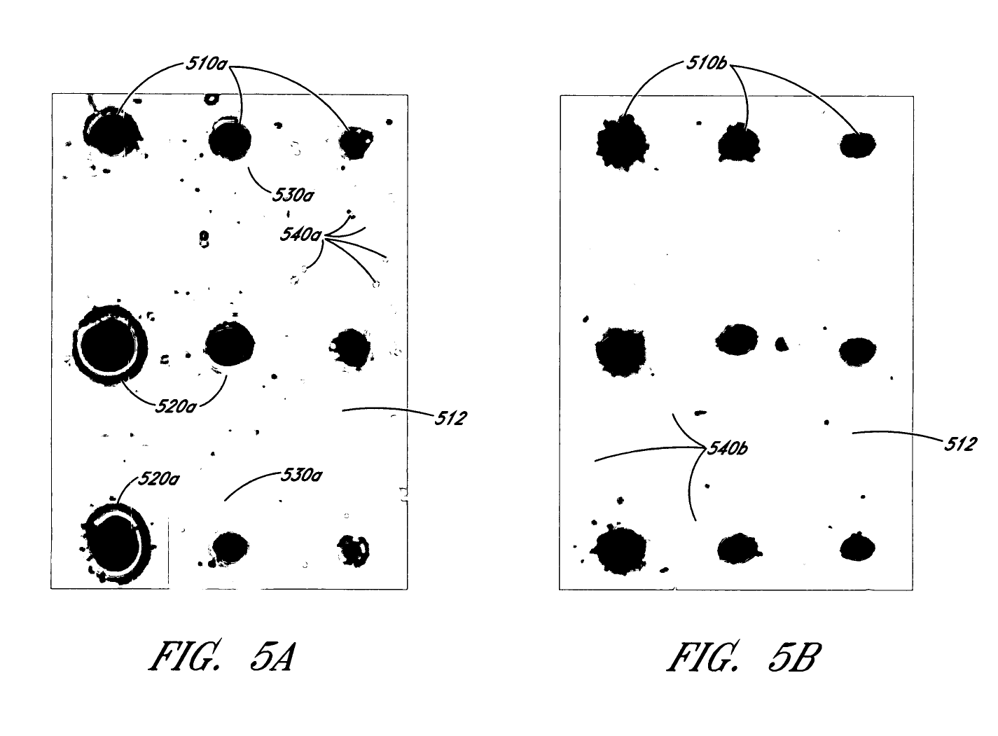

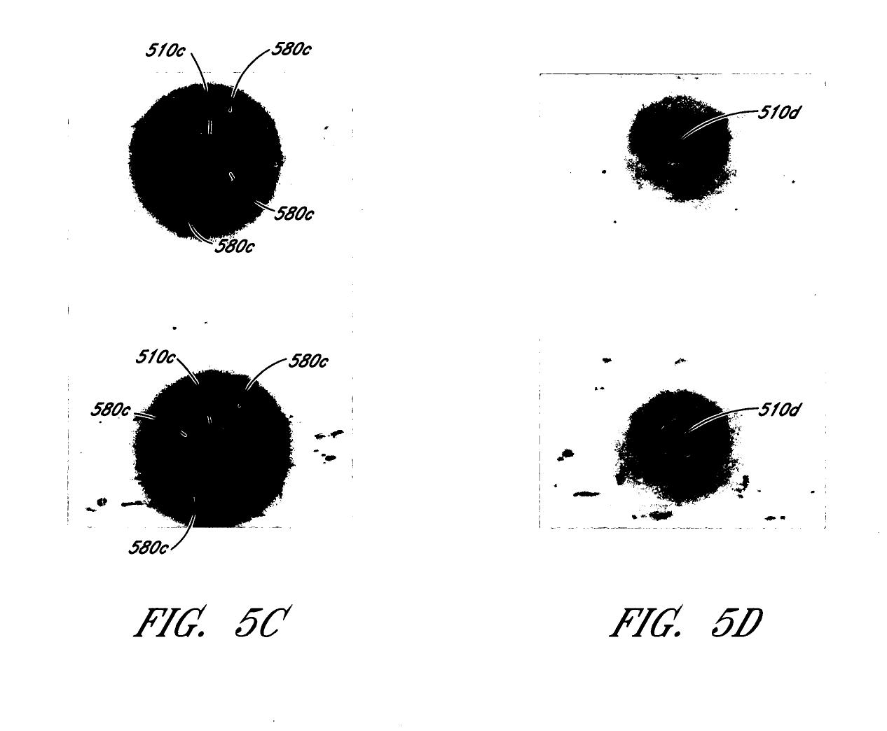

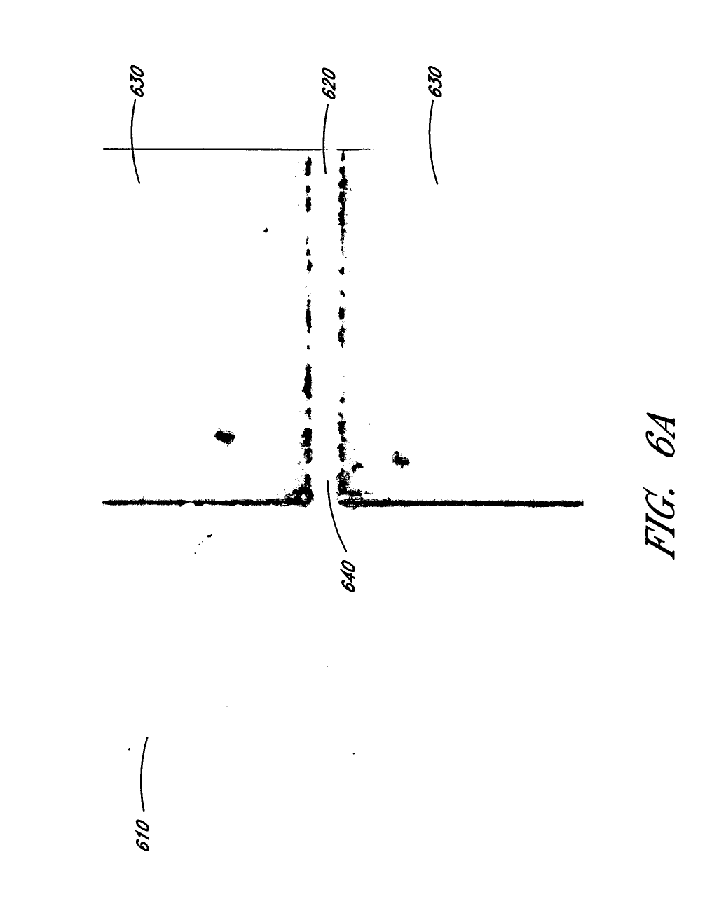

FIGS. 5A and 5B are optical micrographs showing the results of the comparison experiment. For each of the two wavelengths, three circular features 510a, 510b at three different values of the laser fluence were machined in the PET material 512. In FIG. 5A, the fluences were, from left to right: 0.40, 0.16, and 0.10 J/cm². In FIG. 5B, the fluences were, from left to right: 0.24, 0.15, and 0.10 J/cm². One thousand incident laser pulses were used to machine each circular feature. In FIGS. 5A and 5B, fluence decreases from left to right along each row of holes, while fluence is substantially constant from top to bottom along each column of holes.

FIGS. 5A and 5B indicate that machining with 522-nm femtosecond pulses is a more precise, controllable, and repeatable process than machining with 1045-nm femtosecond pulses. The features 510b generated with 522 nm pulses at constant fluence (e.g., in a column) are quite similar in size and appearance for each value of the fluence. In contrast, the features 510a generated with the 1045 nm pulses show poor precision, with the same applied laser fluence resulting in different feature sizes and appearances.

FIG. 5A indicates the variability of the features 510a produced with 1045-nm pulses. Some of the 1045-nm machined features 510a show alternating light and dark shaded regions 520a and bright ringed regions 530a. Optical microscopy reveals that the regions 520a and 530a overlay sub-surface cavities that were likely caused by the formation of hot gases during the laser machining process. FIG. 5B shows that the 522-nm features 510b do not exhibit these variations or the presence of sub-surface cavities.

Additionally, while the edges of the 1045-nm features appear smoother than the edges of the 522-nm features, the diameters of the 1045-nm features are different for the same fluence, which may indicate large-scale melting of the material. The “splatter” 540a, 540b surrounding the features 510a, 510b indicates melting on a smaller scale, and, although evident to some extent in both FIGS. 5A and 5B, the splatter is much reduced in the 522-nm process. Further, small-scale melting is known to occur even for “cold” UV photo-ablation processing of polymers under some conditions. In other embodiments of the micromachining methods, different materials may be machined, for example, other polymers, glasses, dielectrics, and metals.

FIGS. 5C and 5D are optical micrographs showing high quality results of micromachining with green light as compared to infrared light. In FIGS. 5C and 5D, pairs of circular features 510c and 510d were micromachined in gold using ultrashort laser pulses having 1045-nm wavelength (FIG. 5C) and 522-nm wavelength (FIG. 5D). The laser pulses had a duration of about 450 fs and a repetition rate of about 800 kHz. The circular features 510c, 510d have diameters of about 7-8 microns. The fluence was about 0.7 J/cm² at 1045 nm and about 0.3 J/cm² at 522 nm. The micromachining performed at 1045 nm shows areas of severe oxidation 580c around the circular features 510c, while the micromachining performed at 522 nm shows no such oxidative areas around the features 510d. The oxidative areas 580c shown in FIG. 5C are evidence of greater material heating at 1045 nm than at 522 nm and are indicative of poor quality micromachining at the comparatively longer wavelength. Another disadvantage of using longer wavelength light is that additional material processing steps are needed to remove the oxidative areas 580c from the material.

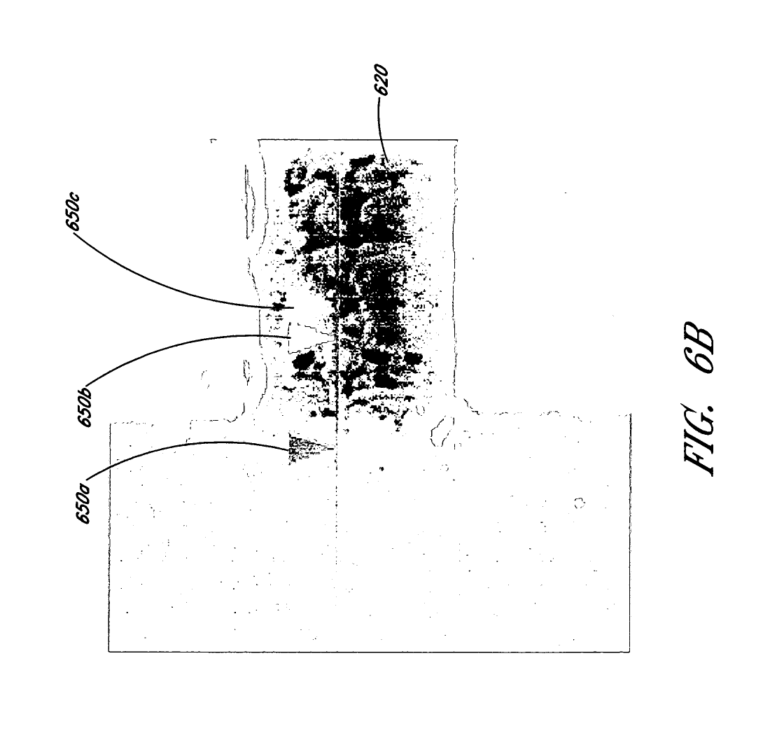

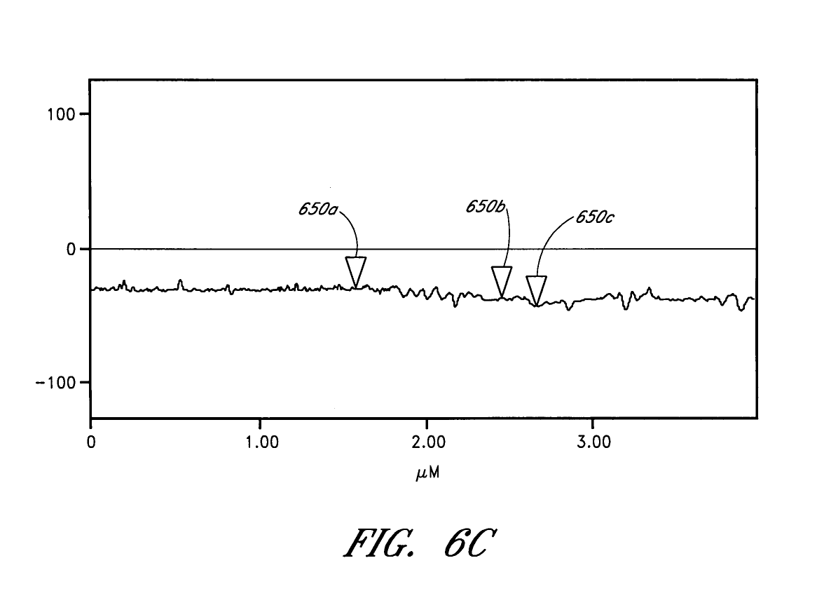

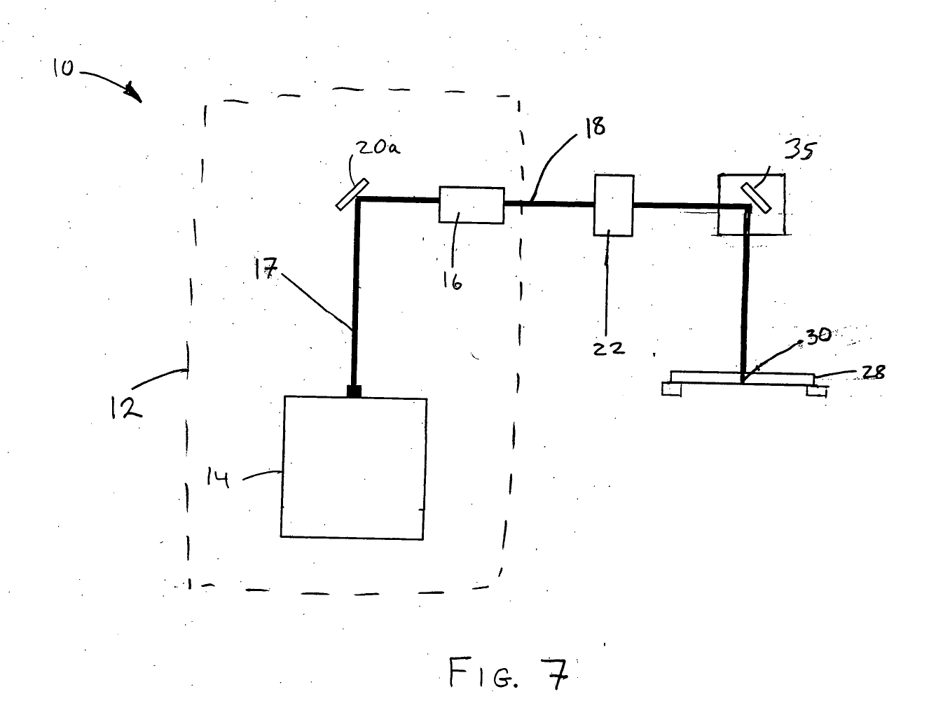

In another experiment showing precise, high-quality laser micromachining with green ultrashort pulses, a portion of a thin chrome film 605 (having a 100-nm thickness) deposited on a quartz photomask 610 was removed using 522-nm ultrashort pulses. The pulse width was about 300 fs, and the pulse repetition rate was 100 kHz. The use of green light (e.g., 522 nm) is beneficial in that the quartz photomask 610 permits transmission of the incident laser light without incurring permanent and significant damage to the quartz material. FIG. 6A is an optical micrograph showing a narrow channel 620 removed from the thin chrome film 630. FIG. 6B is an optical micrograph showing a close-up of a region 640 shown in FIG. 6A. FIG. 6B shows a smooth and well-defined edge bordering the area of removed chrome 620. The edge is machined to within a tolerance of about ±20 nanometers. In some cases the edge tolerance may be ±10 nanometers. Additionally, Figure 6B shows no evidence of the formation of HAZ or sub-surface cavities. Thus, FIGS. 6A and 6B further indicate certain advantages of using green ultrashort pulses to micromachine materials.

FIG. 6C shows an atomic force microscope (AFM) scan of the depth (vertical scale in nanometers; horizontal scale in micrometers) of the quartz photomask 610 in the region 640 where the chrome is removed. For convenience, reference points 650a, 650b,and 650c are marked both in the AFM scan (FIG. 6C) and in the optical micrograph (FIG. 6B). Reference point 650a is located outside the micromachined channel 620, while reference points 650b and 650c are located within the micromachined channel 620. FIG. 6C shows that green femtosecond laser pulses cause minimal damage to the quartz photomask 610, because the variation in depth is only a few nanometers different within the channel 620 (e.g., at reference points 650b,650c) as compared to the unmachined quartz (e.g., at reference point 650a).

The micromachining methods utilizing the system 10 are not limited to the particular materials in the example results shown in FIGS. 6A-6C. Thin films comprising different materials can be removed from a variety of substrates. In certain embodiments of these methods, green femtosecond laser pulses are advantageous in removing metallic thin films from transparent dielectric substrates. In many micromachining processes, the thickness of the thin film is less than the depth of the high-fluence portion of the focused laser beam. Under typical processing conditions, it is generally unavoidable that, prior to and/or subsequent to ablation of the thin film, some laser pulses will be incident upon the accompanying substrate material. In addition to yielding precise, high-quality machining of the thin layer, the use of green light allows a substantial portion of the incident laser radiation to be transmitted through the substrate without incurring permanent and significant damage to the material. If shorter wavelength (blue or ultraviolet) ultrashort pulses were used, there would be an increased likelihood of absorption by, and subsequent damage to, the substrate. Without subscribing to any particular theory or explanation, it is possible (although not required) that the increased likelihood of absorption may be a result of, for example, linear absorption (e.g., in the ultraviolet) or low-order multi-photon absorption (e.g., in the blue). Accordingly, green light femtosecond laser pulses provide superior micromachining results.

In another embodiment of the micromachining methods, visible laser light is used to machine a medium that comprises layers of different materials. For example, the medium may comprise a stack of alternating layers of various materials that include a wide range of absorption coefficients for the wavelength of the incident laser pulses. In some cases, the alternating layers may comprise metals and dielectrics. The combination of shorter illuminating wavelength (e.g., green light) and ultrashort pulse duration is advantageous compared to the separate cases of either longer illuminating wavelength (e.g., infrared) or longer illuminating pulse duration. In addition to the increased precision enabled by imaging or simple focusing of comparatively shorter-wavelength light, the ultrashort pulse duration enables machining of both metallic and dielectric layers with a minimal amount of potentially deleterious heating of the material adjacent to the machined regions.

Additionally, micromachining with comparatively shorter-wavelength light having ultrashort pulse duration enables controlled removal of material that can be repeated with similar results. For example, the micromachining process can be used to form openings, holes, channels, cuts, grooves, or other features, which have a size and shape that can be repeatably produced. The bottom, top, sides, edges, etc., of the opening, holes, channels, cuts, or grooves, etc., are substantially, regular, smooth, and repeatable. The bottoms, tops, sides, edges, etc., of the features may, for example, have ±10 nm RMS roughness or total variation of between about 20 nm and about 50 nm. Likewise, substantially straight channels can be formed ranging from about 5 micrometers to several centimeters in length and from about 100 nanometers to several hundred micrometers in width to within a tolerance of about 1% of the width of the channel on each side. Openings, holes, channels, cuts, grooves, etc., having other shapes are also possible. Accordingly, micromachining may include, for example, milling or cutting or drilling to provide sharp-edged, smooth, and uniform surfaces (e.g., edges, sides, bottoms, and tops) in microstructural features. Roughness may be less than about 100 nanometers RMS. Micromachining may also be used in scribing, and in grooving, in some embodiments. Advantageously, the micromachining is precise, controllable, and repeatable over a wide range of laser fluences.

For the case of dielectric layers that are generally optically transparent for wavelengths greater than an ionization bandgap of the material, λ_{g}, the use of shorter wavelength light permits micromachining at lower fluences, which generally results in superior quality and precision in the machining process due to reduced material heating and HAZ formation. For example, during micromachining of transparent materials, material defects and debris generated. Such defects and debris can absorb light, which can result in heating, melting, or burning of the surrounding material. If the machining of the transparent material is performed at a lower fluence, there will be less energy to cause heating in the regions near the machined portions. As described above, one possible (although not required) explanation for the decreased heating is that the ablation threshold is lower for shorter wavelength (e.g., green) light, because, for example, multi-photon ionization processes occur at an increased rate at shorter wavelengths. For example, experiments show that many transparent materials have a lower ablation threshold with green (e.g., 522 nm) light than infrared (e.g., 1045-nm) light. Accordingly, lower fluences may be used with green light, which will cause less material heating than, for example, infrared light.

In certain embodiments, the system 10 is configured to dice a processed semiconductor wafer into individual components, e.g., individual “chips.” In these embodiments, laser micromachining of the semiconductor wafer is advantageous, as compared to the use of a wafer dicing saw, because laser micromachining avoids significant damage to the individual “chips.” For example, many “low-k” dielectrics tend to crack and chip if they are cut with a wafer dicing saw blade, and these cracks can propagate to and damage the individual “chips.” Laser micromachining with ultrashort visible pulses advantageously avoids this cracking and chipping, because, for example, no physical saw blade comes into contact with the semiconductor wafer.

In other embodiments, the system 10 can be configured to cut glass, crystal, sapphire, calcium fluoride, and other dielectric materials into smaller pieces. For example, such embodiments may be used for “scribe and break” processes, in which a groove is machined on the surface of a sheet of material, and the sheet is subsequently cleaved (e.g., by mechanical, thermal, or other methods). Such embodiments may also be used to cut other materials such as, for example, metals and semiconductors.

In certain embodiments, the system 10 can be used to pattern grooves in a dielectric material, such as glass or crystal. These embodiments may be used, for example, to fabricate microfluidic circuits in which grooves in the material are used to channel fluids. Additionally, embodiments may use groove cutting for various “scribe and break” processes so as to break a larger sheet of material into smaller pieces in a controlled fashion. For example, such embodiments may be used to machine glass, and in particular borosilicate glass, which may be used for flat panel displays, including cell phones, laptops, televisions, displays, and personal digital assistants.

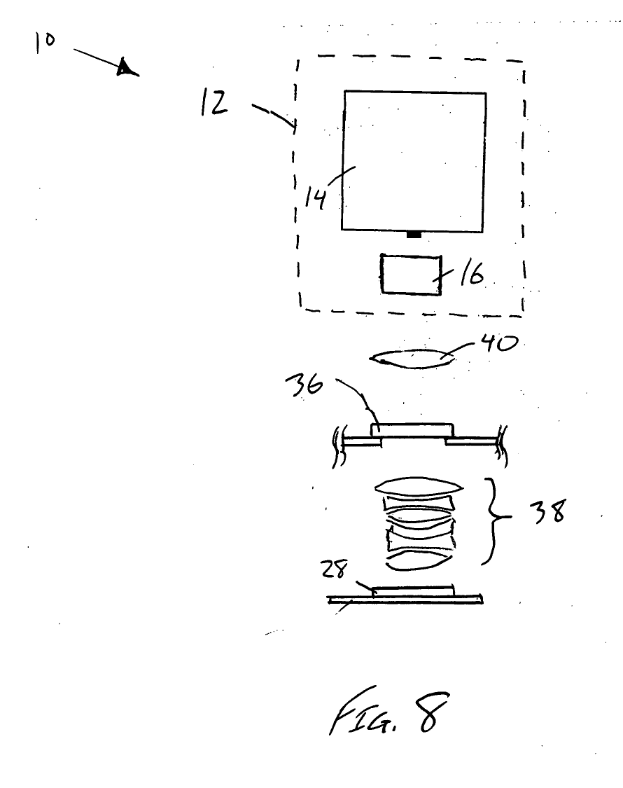

As described above, the configuration of the micromachining system may be different and variations in micromachining methods are possible. One example alternative embodiment is shown in FIG. 7. FIG. 7 illustrates an embodiment of a system 10 in which the 1045-nm pulsed laser beam 17 emitted from the laser light source 14 is directed into the frequency doubler 16 by the mirror 20a. The mirror 20a can be rotated or tilted to provide a suitable optical path. The translation system 32 in this system 10 comprises a rotating or tilting mirror 35, which may be supported on one or more stages that provides rotation and/or tilting. The beam may be directed to different locations on the material 28 to be processed by moving the mirror 35. This system 10 does not include focusing optics. The laser beam 18 output from the laser source 12 has sufficiently reduced transverse cross-section. Although not shown, the system 10 may further comprise a sample translation stage 34 as well. Other variations are also possible.

FIG. 8 shows a micromachining system 10 that does not include a translation system 32. The visible light 18 illuminates a mask 36 that forms a pattern on or in the medium 28 that is illuminated by the visible light 18. Imaging optics 38 for imaging the mask 36 is also shown. The system 10 further include illumination optics 40 disposed between the laser source 12 and the mask 36 for illuminating the mask with the laser light. Although not shown, the system 10 may further comprises a sample translation stage 34, a mask translators or stepper, or translator, tilt, or rotation stages for the optics, as well. Accordingly, in other embodiments, a mask or reticle may be employed in addition to translating or stepping the medium, the mask, and/or the beam.

Other variations in the apparatus and method described herein are possible. For example, components may be added, removed, or arranged or configured differently. Similarly, processing steps may be added, removed, reordered, or performed differently.

Embodiments of the system 10 may be used in a variety of micromachining processes. For example, a beam of visible ultrashort laser pulses may be used to drill, cut, scribe, groove, mill, etch, and weld a variety of materials including, for example, many metals, semiconductors and dielectrics (e.g., glasses and crystals). The system 10 may be used in processes such as, for example, micropatterning, microfluidics, microelectromechanical systems (MEMS), lithography, semiconductor fabrication, thin film removal, “scribe and break” processing, bearing surface structuring, and via-hole drilling. Many other processes are possible.

While certain embodiments of the invention have been described, these embodiments have been presented by way of example only, and are not intended to limit the scope of the present invention. Accordingly, the breadth and scope of the present invention should be defined in accordance with the following claims and their equivalents.

What is claimed is:

1. A method comprising:
producing a visible light beam comprising femtosecond optical pulses having a wavelength between about 490 and 550 nanometers;
micromachining a region of a surface by directing at least a portion of said visible light beam into said region of said surface.

2. The method of claim 1, wherein said visible light beam is green.

3. The method of claim 2, wherein said femtosecond optical pulses have a wavelength between about 500 and 550 nanometers.

4. The method of claim 1, wherein said femtosecond optical pulses have a pulse duration between about 200 and 500 femtoseconds.

5. The method of claim 1, wherein said femtosecond optical pulses have a pulse duration between about 300 and 700 femtoseconds in duration.

6. The method of claim 1, further comprising producing infrared light and frequency doubling said infrared light to produce said visible light beam.

7. The method of claim 6, wherein said frequency doubling comprises second harmonic generation.

8. The method of claim 6, wherein said infrared light comprises laser light of about 1040 nanometers and said visible light beam comprises laser light of about 520 nanometers.

9. The method of claim 6, further comprising pulsing said infrared light at a repetition rate between about 100 kHz to 5 MHz.

10. The method of claim 1, wherein said micromachining comprises cutting a portion of said surface.

11. The method of claim 1, wherein said micromachining comprises drilling or milling a portion of said surface.

12. The method of claim 1, wherein said micromachining comprises scribing or grooving a portion of said surface.

13. The method of claim 1, wherein said surface comprises a metal.

14. The method of claim 1, wherein said surface comprises a semiconductor.

15. The method of claim 1, wherein said surface comprises a dielectric.

16. The method of claim 15, wherein said dielectric comprises glass or quartz.

17. The method of claim 16, wherein said glass comprises borosilicate glass.

18. The method of claim 1, wherein surface comprises crystal or polymer.

19. The method of claim 1, wherein said surface comprises a thin film on a substrate.

20. The method of claim 19, wherein said thin film comprises a metal.

21. The method of claim 19, wherein said substrate comprises dielectric.

22. The method of claim 19, wherein said substrate comprises glass or crystal.

23. The method of claim 19, wherein said substrate comprises a semiconductor.

24. The method of claim 1, wherein said surface comprises alternating layers comprising different materials.

25. The method of claim 1, wherein said micromachining produces a micromachined edge that is substantially smooth.

26. The method of claim 25, wherein said micromachined edge has a surface roughness less than about 1 micrometer RMS

27. The method of claim 25, wherein said micromachined edge has a surface roughness less than about 100 nanometers RMS.

28. The method of claim 25, wherein said micromachined edge has a surface roughness less than about 10 nanometers RMS.

29. A system for micromachining, said system comprising:
a light source producing a beam of visible light comprising femtosecond pulses having a wavelength between about 490 and 550 nanometers; and
material positioned in said beam,
wherein said material is micromachined by said beam.

30. The system of claim 29, wherein said light source comprises a laser.

31. The system of claim 29, wherein said light source is configured to output a green light beam having a wavelength of between about 500 to 550 femtoseconds.

32. The system of claim 29, wherein said light source is configured to output pulses having a duration of between about 200 to 500 femtoseconds.

33. The system of claim 29, wherein said light source is configured to output pulses having a duration of between about 300 to 700 femtoseconds.

34. The system of claim 29, wherein said visible laser light source comprises an infrared laser and a frequency doubler.

35. The system of claim 34, wherein said infrared laser comprises a Yb-doped fiber laser.

36. The system of claim 35, wherein said light source further comprises a pulse stretcher, an amplifier, and a compressor.

37. The system of claim 29, wherein said micromachining comprises cutting a portion of said material.

38. The system of claim 29, wherein said micromachining comprises drilling or milling a portion of said material.

39. The system of claim 29, wherein said micromachining comprises scribing or grooving a portion of said material.

40. The system of claim 29, wherein said material comprises a metal.

41. The system of claim 29, wherein said material comprises a semiconductor.

42. The system of claim 29, wherein said material comprises a dielectric.

43. The system of claim 42, wherein said dielectric comprises glass or quartz.

44. The system of claim 43, wherein said glass comprises borosilicate glass.

45. The system of claim 29, wherein material comprises crystal or polymer.

46. The system of claim 29, wherein said material comprises a thin film on a substrate.

47. The system of claim 46, wherein said thin film comprises a metal.

48. The system of claim 46, wherein said substrate comprises dielectric.

49. The system of claim 46, wherein said substrate comprises glass or crystal.

50. The system of claim 46, wherein said substrate comprises a semiconductor.

51. The system of claim 29, wherein said material comprises alternating layers comprising different materials.

52. The system of claim 29, wherein said micromachining produces a micromachined edge that is substantially smooth.

53. The system of claim 52, wherein said micromachined edge has a surface roughness less than about 1 micrometer RMS

54. The system of claim 52, wherein said micromachined edge has a surface roughness less than about 100 nanometers RMS.

55. The system of claim 52, wherein said micromachined edge has a surface roughness less than about 10 nanometers RMS.

56. A system for performing micromachining on an object, said system comprising:
a visible laser light source that outputs a visible light beam comprising femtosecond duration optical pulses having a wavelength between about 490 and 550 nanometers and illuminates a spatial region of said object with said visible light; and
a translation system for translating said beam or said spatial region;
wherein said translation system is configured to alter the relative position of the beam and object such that said visible laser beam micromachines the object.

57. The system of claim 56, wherein said visible laser light source comprises an infrared laser and a frequency doubler.

58. The system of claim 57, wherein said infrared laser comprises a Yb-doped fiber laser.

59. The system of claim 57, wherein said infrared laser comprises a laser that operates at a wavelength of approximately 1045 nanometers and said frequency doubler comprises a nonlinear optical element that produces light having a wavelength of about 522.5 nanometer through second harmonic generation.

60. The system of claim 56, wherein said visible laser light source has a repetition rate between about 100 kHz to 5 MHz.

61. The system of claim 56, further comprising optics disposed to receive said visible light beam output from said visible laser light source and illuminate said spatial region with said visible light.

62. The system of claim 61, wherein said optics comprises a microscope objective.

63. The system of claim 56, wherein said translation system comprises a translation stage on which said object is disposed.

64. The system of claim 56, wherein said translation system comprises a movable mirror.

65. The system of claim 56, wherein said visible laser light source is configured to output optical pulses having a duration of between about 200 to 500 femtoseconds.

66. The system of claim 56, wherein said visible laser light source is configured to output optical pulses having a duration of between about 300 to 700 femtoseconds.
